(19) United States
(12) Patent Application Publication
(10) Pub. No.: US 2013/0244086 A1
(43) Pub. Date: Sep. 19, 2013

(54) NEGATIVE ELECTRODE FOR SECONDARY BATTERY AND METHOD FOR MANUFACTURING THE SAME, AND NONAQUEOUS ELECTROLYTE SECONDARY BATTERY

(71) Applicants: Jiro Iriyama, Kanagawa (JP); Daisuke Kawasaki, Kanagawa (JP); Ryuichi Kasahara, Kanagawa (JP); Tetsuya Kajita, Kanagawa (JP); Tatsuji Numata, Kanagawa (JP)

(72) Inventors: Jiro Iriyama, Kanagawa (JP); Daisuke Kawasaki, Kanagawa (JP); Ryuichi Kasahara, Kanagawa (JP); Tetsuya Kajita, Kanagawa (JP); Tatsuji Numata, Kanagawa (JP)

(73) Assignee: NEC ENERGY DEVICES, LTD., Kanagawa (JP)

(21) Appl. No.: 13/820,369

(22) PCT Filed: Aug. 25, 2011
(86) PCT No.: PCT/JP2011/069165

§ 371 Date: Mar. 1, 2013

(30) Foreign Application Priority Data
Sep. 3, 2010 (JP) 2010-197835

(51) Int. Cl. H01M 4/62; H01M 4/66

(52) U.S. Cl. CPC H01M 4/622; H01M 4/662
USPC 429/163; 429/211; 427/58; 427/126.3; 427/123

(57) ABSTRACT

Provided are a negative electrode for a secondary battery realizing satisfactory cycle characteristics and a method for manufacturing the same, and a nonaqueous electrolyte secondary battery having satisfactory cycle characteristics. A negative electrode for a secondary battery formed by bonding a negative electrode active material to a negative electrode collector with a negative electrode binder, in which the negative electrode binder is a polyimide or a polyamide-imide, and the negative electrode collector is a Cu alloy containing at least one metal (a) selected from the group consisting of Sn, In, Mg and Ag and has a conductivity of 50 IACS % or more. The negative electrode for a secondary battery can be manufactured by a method including forming a negative electrode layer containing the negative electrode active material and the precursor of the negative electrode binder on the negative electrode collector; and bonding the negative electrode active material to the negative electrode collector with the negative electrode binder by curing the precursor of the negative electrode binder at 250 to 350° C.

### TECHNICAL FIELD

The exemplary embodiment relates to a negative electrode for a secondary battery and a method for manufacturing the same, and a nonaqueous electrolyte secondary battery.

### BACKGROUND ART

With rapid market expansion of notebook computers, mobile phones, electric cars and the like, a high energy-density secondary battery has been desired. Examples of a method for obtaining a high energy-density secondary battery include a method of using a high-capacity negative electrode material and a method of using a nonaqueous electrolyte having excellent stability. Furthermore, recently, a secondary battery that does not easily deteriorate even if charge and discharge are repeated has been desired. Improvement in cycle characteristics is desired.

Lately, investigation has been made on availability of silicon and a silicon oxide as a negative electrode active material having a high energy density. Patent Literature 1 describes use of a silicon-atom containing compound capable of absorbing and desorbing lithium as a negative electrode material. Patent Literature 2 describes a negative electrode containing silicon and/or a silicon alloy as a negative electrode active material and a polyimide as a binder.

However, the electrode using silicon and a silicon oxide as a negative electrode active material has the following problem. Since the negative electrode active material greatly expands and shrinks in absorbing and desorbing lithium, a negative electrode collector wrinkles. As a result, internal short circuit occurs and yield easily reduces. To overcome the problem, use of a highly strong Cu—Ni—Si based alloy and Cu—Cr—Zr based alloy as a negative electrode collector is described in Patent Literature 3.

### CITATION LIST

### Patent Literature

Patent Literature 1: JP2000-12088A
Patent Literature 2: JP2002-260637A
Patent Literature 3: JP2009-81105A

### SUMMARY OF INVENTION

### Technical Problem

However, the Cu—Ni—Si based alloy and Cu—Cr—Zr based alloy have a problem. Since the conductivity of them is extremely low compared to pure Cu, secondary batteries using them as collectors are inferior in large-current charge and discharge characteristics.

In the exemplary embodiment, it is an object to provide a negative electrode for a secondary battery realizing satisfactory cycle characteristics and a method for manufacturing the same, and a nonaqueous electrolyte secondary battery having satisfactory cycle characteristics.

### Solution to Problem

The exemplary embodiment is directed to a negative electrode for a secondary battery formed by bonding a negative electrode active material to a negative electrode collector with a negative electrode binder, in which

the negative electrode binder is a polyimide or a polyamide-imide, and

the negative electrode collector is a Cu alloy containing at least one metal (a) selected from the group consisting of Sn, In, Mg and Ag and has a conductivity of 50 IACS % or more.

The exemplary embodiment is directed to a method for manufacturing the aforementioned negative electrode for a secondary battery, including

forming a negative electrode layer containing the negative electrode active material and a precursor of the negative electrode binder on the negative electrode collector; and

bonding the negative electrode active material to the negative electrode collector with the negative electrode binder by curing the precursor of the negative electrode binder at 250 to 350° C.

The exemplary embodiment is directed to a nonaqueous electrolyte secondary battery formed by wrapping an electrode element, in which a positive electrode and a negative electrode are arranged so as to face each other, and a nonaqueous electrolyte in an outer package, in which the negative electrode is a negative electrode for a secondary battery according to the exemplary embodiment.

### Advantageous Effects of Invention

According to the exemplary embodiment, it is possible to provide a negative electrode for a secondary battery realizing satisfactory cycle characteristics and a method for manufacturing the same, and a nonaqueous electrolyte secondary battery having satisfactory cycle characteristics.

### BRIEF DESCRIPTION OF DRAWING

FIG. 1 is a schematic sectional view showing the structure of an electrode element contained in a laminate-type nonaqueous electrolyte secondary battery.

### DESCRIPTION OF EMBODIMENTS

The exemplary embodiment will be more specifically described below.

<Nonaqueous Electrolyte Secondary Battery>

A nonaqueous electrolyte secondary battery according to the exemplary embodiment is formed by wrapping an electrode element, in which a positive electrode and a negative electrode are arranged so as to face each other, and a nonaqueous electrolyte in an outer package. The nonaqueous electrolyte secondary battery has a negative electrode for a secondary battery according to the exemplary embodiment described later, as a negative electrode. The shape of the nonaqueous electrolyte secondary battery may be any one of a cylindrical type, a flat rectangular rolled type, a rectangular laminate type, a coin type, a flat laminate rolled type and a laminate type; however, a laminate type is preferable. Now, a laminate-type nonaqueous electrolyte secondary battery will be described.

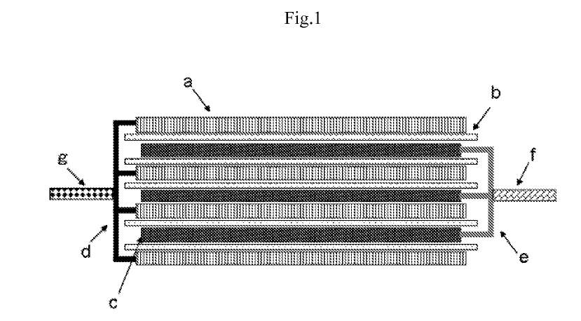

FIG. 1 is a schematic sectional view showing the structure of an electrode element contained in a laminate-type nonaqueous electrolyte secondary battery. The electrode element is formed by laminating a plurality of positive electrodes c and a plurality of negative electrodes a alternately with a separator b interposed between them. Positive electrode collectors e that individual positive electrodes c have are mutually welded to make electrical contacts with each other at the ends not covered with a positive electrode active material. At the welded site, a positive electrode terminal f is further welded. The negative electrode collectors d that individual negative electrodes a have are mutually welded to make electrical contacts with each other at the ends not covered with a negative electrode active material. At the welded site, a negative electrode terminal g is further welded.

The electrode element having such a planar laminate structure does not have a small-radius portion (a region close to a roll core of a rolled structure or a region of a fold-back portion) and thus there is an advantage that the electrode element is rarely affected by a volume change of the electrode caused by charge and discharge compared to the electrode element which has a rolled structure. More specifically, the electrode element is effective in the case of using an active material, which readily causes volume expansion. In contrast, in an electrode element having a rolled structure, since the electrode is bent, the structure is likely to strain if a volume change occurs. Particularly in the case of using a negative electrode active material, such as a silicon oxide, causing a large volume change with charge and discharge, a nonaqueous electrolyte secondary battery using an electrode element having a rolled structure often has a large capacity drop with charge and discharge.

However, the electrode element having a planar laminate structure has a problem in that a gas, if it is generated between electrodes, is likely to remain between the electrodes. This is because, the space between electrodes in an electrode element having a rolled-structure rarely broadens since tensile force is applied between the electrodes; whereas the space between electrodes in an electrode element having a laminate-structure easily broadens. If an aluminum laminate film is used as an outer package, this problem is particularly prominent.

In the exemplary embodiment, it is possible to solve the aforementioned problems. Also, in a laminate-type lithium ion secondary battery using a high energy type negative electrode, a long-life driving can be made.

[1] Negative Electrode

A negative electrode is prepared by bonding a negative electrode active material to a negative electrode collector with a negative electrode binder.

As the negative electrode active material, other than a lithium metal, a carbon material capable of absorbing and desorbing a lithium ion, a metal capable of forming an alloy with lithium, a metal oxide capable of absorbing and desorbing a lithium ion and the like can be used. However, as the negative electrode active material, a metal or metal oxide containing silicon or tin is preferably used since they have a large capacity density. Note that, the metal or metal oxide containing silicon or tin increases a volume by 30 to 200% with charge and discharge.

Examples of the metal containing silicon or tin include a silicon metal, a tin metal, a silicon-tin alloy and an alloy of a silicon metal and/or tin metal with one or two or more metals selected from Al, Pb, In, Bi, Ag, Zn and La. Of them, a silicon metal or a tin metal is preferable since they have a large capacity density. Examples of the metal oxide containing silicon or tin include SiOx (0.8≦x≦2), SnOx (1≦x≦3), a tin oxide, a silicon-tin complex oxide, and complex oxides containing silicon and/or tin and one or two or more metal elements selected from Al, Pb, In, Bi, Ag, Zn and La. Of them, SiOx (0.8≦x≦2) or SnOx (1≦x≦3) is preferable since it has excellent charge-discharge cycle characteristics. Furthermore, if e.g., 0.1 to 5% by mass of one or two or more elements selected from nitrogen, boron and sulfur is added to a metal oxide as mentioned above, the electric conductivity of the metal oxide can be improved. The negative electrode active material can be used singly or in combinations of two or more types.

The negative electrode active material preferably has a particle form. The average particle size D50 of the negative electrode active material particles is preferably 1 to 50 μm. If the average particle size D50 is less than 1 μm, particles easily aggregate. As a result, preparation of an electrode may become difficult. In addition, if the average particle size D50 is larger than 50 μm, it is sometimes difficult to reduce the thickness of an electrode, with the result that keeping balance with the capacity of a positive electrode may become difficult. This is because the capacity of the positive electrode such as lithium manganese oxide and lithium nickel oxide per volume is significantly small compared to that of a Si based negative electrode. Note that, the average particle size D50 can be measured, for example, by a laser diffraction type particle-size distribution measuring device.

As the negative electrode collector, a Cu alloy containing at least one metal (a) selected from the group consisting of Sn, In, Mg and Ag is used. Generally, Cu foil is often used as the negative electrode collector. Cu is characterized in that tensile strength drastically reduces at 150° C. (semi-softening temperature). The semi-softening temperature can be increased, for example, to 300° C. or more by making an alloy of Cu with a metal (a). Because of this, even if a polyimide or a polyamide-imide is used as a negative electrode binder and a precursor of the negative electrode binder is cured at 250 to 350° C., the tensile strength of the negative electrode collector does not decrease and satisfactory cycle characteristics can be attained.

The Cu alloy serving as a negative electrode collector preferably contains 0.01 to 0.3% by mass of metal (a), and more preferably 0.05 to 0.2% by mass of metal (a). The Cu alloy serving as a negative electrode collector preferably contains Sn as a metal (a). The metals (a) can be used singly or in combinations of two or more types.

However, if Cu is alloyed, the conductivity of the Cu alloy is generally reduced. As a result, a problem in which large-current charge and discharge characteristics is deteriorated sometimes occurs. Then, a material having a conductivity of 50 IACS % or more is selected as a negative electrode collector. The conductivity of a negative electrode collector is preferably 70 IACS % or more and more preferably 80 IACS % or more. The higher the conductivity of a negative electrode collector, the more preferable. The conductivity may be beyond 100 IACS % like in the case of a Cu alloy with Ag, which has a higher conductivity than Cu; however, in view of cost, usually a material having a conductivity of 102 IACS % or less is used. Note that, the unit of conductivity, “IACS %” refers to a ratio of a Cu-alloy conductivity relative to 100% of the pure Cu conductivity.

Note that, the conductivity of a Cu alloy can be calculated in accordance with the Matthiessen's rule. More specifically, the specific resistance ρ_{Alloy} of a Cu alloy can be calculated in accordance with the following expression using the specific resistance ρₚᵤᵣₑ of pure Cu, concentration C of a metal to be alloyed and contribution Δρᵢ to the specific resistance per unit concentration.

ρ_{Alloy}=ρpure+CΔρᵢ

Values of Δρᵢ of various metals are described, for example, in “Asakura Metal Engineering

Series, Non-Iron Metal Material Science”, written by Yotaro Murakami and Kiyoshi Kamei, first edition, first printing, Asakura Publishing Co., Ltd., published in April 1978, p. 13.

The Cu alloy serving as a negative electrode collector has a semi-softening temperature of preferably 250° C. or more and more preferably 300 to 375° C. Note that, the semi-softening temperature of a Cu alloy is described, for example, in JP2009-108379A.

Examples of the shape of the negative electrode collector include foil, a flat-plate and a mesh. The thickness of the negative electrode collector is preferably 7 to 20 μm.

As a negative electrode binder, a polyimide or a polyamide-imide is used since they have strong bonding property. The amount of negative electrode binder is preferably 5 to 25 parts by mass relative to 100 parts by mass of the negative electrode active material in view of a tradeoff between “sufficient bonding force” and “energy enhancement”.

The negative electrode can be prepared by forming a negative electrode active material layer containing a negative electrode active material on a negative electrode collector. More specifically, a negative electrode active material layer can be formed by applying negative electrode slurry containing a negative electrode active material to a negative electrode collector, followed by drying and press-molding. The negative electrode slurry can be obtained by dispersing a negative electrode active material together with a negative electrode binder in a solvent such as N-methyl-2-pyrrolidone (NMP) and kneading the dispersion. Examples of a method of applying the negative electrode slurry include a doctor blade method and a die coater method. At this time, the negative electrode active material layer is formed by bonding the negative electrode active material so as to cover the negative electrode collector with the negative electrode binder.

Furthermore, a negative electrode active material layer may be formed by forming a negative electrode layer containing a negative electrode active material and a precursor of a negative electrode binder on a negative electrode collector, and curing the precursor of a negative electrode binder. More specifically, a negative electrode active material layer may be formed by applying a negative electrode slurry containing a negative electrode active material and a precursor of a negative electrode binder to a negative electrode collector, followed by drying, to form a negative electrode layer, and curing the precursor of a negative electrode binder contained in the negative electrode layer. The negative electrode slurry can be obtained by dispersing a negative electrode active material together with a precursor of a negative electrode binder in a solvent such as N-methyl-2-pyrrolidone (NMP) and kneading the dispersion. Examples of a method for applying negative electrode slurry include a doctor blade method and a die coater method. As the precursor of a negative electrode binder, a polyamic acid, which is a precursor of a polyimide, can be used. The curing temperature is preferably 250 to 350° C. and more preferably 300 to 350° C. The curing time is preferably 30 to 80 minutes. As described above, a negative electrode active material can be bonded to a negative electrode collector with a negative electrode binder.

[2] Positive Electrode

A positive electrode can be formed, for example, by bonding a positive electrode active material to a positive electrode collector with a positive electrode binder.

Examples of the positive electrode active material include a lithium manganese oxide having a laminate structure or a lithium manganese oxide having a spinel structure, such as LiMnO₂ and LiₓMn₂O₄ (0<x<2); LiCoO₂, LiNiO₂ or a compound obtained by substituting a part of the transition metal of these with another metal; a lithium transition metal oxide such as LiNi_{1/3}Co_{1/3}Mn_{1/3}O₂ in which the ratio of a predetermined transition metal is not beyond a half; and these lithium transition metal oxides containing Li stoichiometrically excessively. Particularly, Li_{α}Ni_{β}Co_{γ}Al_{δ}O₂ (1≦α≦1.2, β+γ+δ=1, β≧0.7, γ≦0.2) or Li_{α}Ni_{β}Co_{γ}Mn_{δ}O₂ (1≦α≦1.2, β+γ+δ=1, β≧0.6, γ≦0.2) is preferable. The positive electrode active materials may be used singly or in combinations of two or more types.

As the positive electrode collector, aluminum, nickel, copper, silver and alloys of these are preferable in view of electrochemical stability. Examples of the shape of the positive electrode collector include foil, a flat-plate and a mesh.

As the positive electrode binder, polyvinylidene fluoride, a vinylidene fluoride-hexafluoropropylene copolymer, a vinylidene fluoride-tetrafluoroethylene copolymer, a styrene-butadiene copolymer rubber, polytetrafluoroethylene, polypropylene, polyethylene, polyimide, polyamide-imide and the like can be used. Of them, polyvinylidene fluoride is preferable in view of versatility and low cost. The amount of positive electrode binder to be used is preferably 2 to 10 parts by mass relative to 100 parts by mass of the positive electrode active material in view of a tradeoff between “sufficient bonding force” and “energy enhancement”.

The positive electrode can be prepared by forming a positive electrode active material layer containing a positive electrode active material on a positive electrode collector. More specifically, a positive electrode active material layer can be formed by applying positive electrode slurry containing a positive electrode active material to a positive electrode collector, followed by drying and press-molding. The positive electrode slurry can be obtained by dispersing a positive electrode active material together with a positive electrode binder in a solvent such as N-methyl-2-pyrrolidone (NMP) and kneading the dispersion. Examples of a method of applying the positive electrode slurry include a doctor blade method and a die coater method. At this time, the positive electrode active material layer is formed by bonding the positive electrode active material so as to cover the positive electrode collector with the positive electrode binder.

To the positive electrode active material layer, a conductive aid may be added in order to reduce impedance. Examples of the conductive aid include carbonaceous fine particles formed of e.g., graphite, carbon black and acetylene black; carbon fibers such as vapor growth carbon fiber (VGCF) and carbon nanotube; and conductive polymers such as polyaniline, polypyrrole, polythiophene, polyacetylene and polyacene.

[3] Separator

As the separator, a porous film and unwoven cloth formed of e.g., polypropylene and polyethylene can be used. Furthermore, a laminate of them can be used as the separator.

[4] Nonaqueous Electrolyte

A nonaqueous electrolyte is prepared by adding a supporting salt to an aprotic organic solvent.

Examples of the aprotic organic solvent that can be used include cyclic carbonates such as propylene carbonate (PC), ethylene carbonate (EC), butylene carbonate (BC) and vinylene carbonate (VC); chain-form carbonates such as dimethyl carbonate (DMC), diethyl carbonate (DEC), ethylmethyl carbonate (EMC) and dipropyl carbonate (DPC); aliphatic carboxylic acid esters such as methyl formate, methyl acetate and ethyl propionate; γ-lactones such as γ-butyrolactone; chain-form ethers such as 1,2-diethoxyethane (DEE) and ethoxymethoxyethane (EME); cyclic ethers such as tetrahydrofuran and 2-methyltetrahydrofuran; dimethyl sulfoxide, 1,3-dioxolane, formamide, acetamide, dimethylformamide, dioxolane, acetonitrile, propylnitrile, nitromethane, ethylmonoglyme, phosphotriester, trimethoxymethane, a dioxolane derivative, sulfolane, methylsulfolane, 1,3-dimethyl-2-imidazolidinone, 3-methyl-2-oxazolidinone, a propylene carbonate derivative, a tetrahydrofuran derivative, ethyl ether, anisole, N-methylpyrrolidone, fluorinated ether, a fluorinated carboxylic acid ester and a fluorinated phosphate ester. The aprotic organic solvents may be used singly or as a mixture of two or more types.

Examples of the supporting salt that can be used include LiPF₆, LiAsF₆, LiAlCl₄, LiClO₄, LiBF₄, LiSbF₆, LiCF₃SO₃, LiC₄F₉CO₃, LiC(CF₃SO₂)₃, LiN(CF₃SO₂)₂, LiN(C₂F₅SO₂)₂, LiB₁₀Cl₁₀, lithium esters of a lower-weight aliphatic carboxylic acid, lithium chloroborate, lithium tetraphenylborate, LiCl, LiBr, LiI, LiSCN, LiCl and imides. The supporting salts may be used singly or as a mixture of two or more types.

The concentration of a supporting salt in a nonaqueous electrolyte is preferably 0.5 to 1.5 mol/l. If the concentration of a supporting salt is 0.5 mol/l or more, a desired ion conductivity can be attained. If the concentration of a supporting salt is 1.5 mol/l or less, it is possible to suppress a reduction of ion conductivity due to an increase of viscosity of a nonaqueous electrolyte.

[5] Outer Package

As an outer package, any material can be appropriately selected as long as it is stable in a nonaqueous electrolyte and has sufficient water vapor barrier properties. For example, in the case of a laminate-type nonaqueous electrolyte secondary battery, a laminate film formed of polypropylene or polyethylene coated with aluminum or silica can be used as an outer package. Particularly, an aluminum laminate film is preferably used in view of suppressing volume expansion.

In the case of a nonaqueous electrolyte secondary battery using a laminate film as an outer package, the strain of an electrode element extremely increases if a gas is generated, compared to a nonaqueous electrolyte secondary battery using a metal can as an outer package. This is because the laminate film is readily deformed by inner pressure of a nonaqueous electrolyte secondary battery compared to a metal can. Furthermore, in sealing a nonaqueous electrolyte secondary battery using a laminate film as an outer package, since the inner pressure of the battery is generally lowered from the atmospheric pressure, an extra space is not left inside. Thus, if a gas is generated, a volume change of the battery and deformation of the electrode element are directly caused by the gas.

However, a nonaqueous electrolyte secondary battery according to the exemplary embodiment can overcome problems as mentioned above. As a result, it is possible to provide a laminate-type lithium ion secondary battery manufactured at low cost and having an excellent degree of freedom in designing a cell capacity by changing a number of layers.

### EXAMPLES

The exemplary embodiment will be more specifically described as follows by way of Examples.

### Example 1

### Preparation of Negative Electrode

Silicon monoxide (manufactured by Kojundo Chemical Lab. Co., Ltd., average particle size D50=25 μm) as a negative electrode active material, carbon black (trade name: #3030B manufactured by Mitsubishi Chemical Corporation) as a conductive agent and polyamic acid (trade name: U-vanish A, manufactured by Ube Industries, Ltd.) as a precursor of a negative electrode binder were weighed in a mass ratio of 83:2:15. These were blended in n-methyl pyrrolidone (NMP) by a homogenizer to obtain negative electrode slurry (solid content: 43% by mass). The obtained negative electrode slurry was applied to Cu-0.1 Sn foil (meaning a Cu alloy containing 0.1% by mass of Sn (the same applies hereinafter), a semi-softening temperature: 330° C., a conductivity: 91 IACS %) having a thickness of 15 μm and serving as a negative electrode collector, by use of a doctor blade. Thereafter, it was dried at 120° C. for 7 minutes to form a negative electrode layer on the negative electrode collector. After that, it was treated with heat by using an electric furnace at 250° C. for 30 minutes under a nitrogen atmosphere to cure the precursor of a negative electrode binder to obtain a polyimide serving as a negative electrode binder. In this manner, a negative electrode was obtained.

(Preparation of Positive Electrode)

Lithium nickel oxide (LiNiO₂, manufactured by Tanaka Chemical Corporation) as a positive electrode active material, carbon black (trade name: #3030B manufactured by Mitsubishi Chemical Corporation) as a conductive agent and polyvinylidene fluoride (trade name: #2400, manufactured by Kureha Corporation) as a positive electrode binder were weighed in mass ratio of 95:2:3. These were blended in n-methylpyrrolidone (NMP) by a homogenizer to obtain positive electrode slurry (solid content: 48% by mass). The obtained positive electrode slurry was applied to aluminum foil having a thickness of 15 μm and serving as a positive electrode collector by use of a doctor blade. Thereafter, it was dried at 120° C. for 5 minutes to obtain a positive electrode.

(Preparation of Nonaqueous Electrolyte Secondary Battery)

To the positive electrode and the negative electrode, an aluminum terminal and a nickel terminal were welded respectively. Thereafter, the positive electrode and the negative electrode were laminated with a separator formed of polypropylene interposed between them to prepare an electrode element. After the obtained electrode element was wrapped with a laminate film (aluminum-evaporated polypropylene film), a nonaqueous electrolyte was injected, and thermal fusion of the laminate film is performed while reducing pressure to seal the film. In this manner, a laminate-type nonaqueous electrolyte secondary battery was prepared. Note that, the nonaqueous electrolyte used herein was prepared by adding 1.0 mol/l of a LiPF₆ electrolyte salt to a solvent mixture of ethylene carbonate and diethyl carbonate in a volume ratio of 7:3.

(Evaluation of Nonaqueous Electrolyte Secondary Battery)

The nonaqueous electrolyte secondary battery was charged and discharged within the range of a voltage 4.2 V to 3.0 V. Note that, the battery was charged in accordance with a CCCV system (a constant current (1C) is supplied up to 4.2 V, and after the voltage is reached to 4.2V, the voltage is maintained at a constant level for one hour); the battery was discharged in accordance with a CC system (a constant current (1C)). Herein 1C current means, when a battery having an arbitrary capacity is discharged at a constant current, the magnitude of current that can finish the discharge for one hour. Then, initial discharge capacity and 200th cycle discharge capacity were measured and the capacity retention rate after 200 cycles (discharge capacity of 200th cycle relative to the initial discharge capacity) was calculated. The results are shown in Table 1.

### Example 2

Preparation was performed in the same manner as in Example 1 except that Cu-0.2 In foil (semi-softening temperature: 320° C., conductivity: 83 IACS %) having a thickness of 15 μm was used as a negative electrode collector. The results are shown in Table 1.

### Example 3

Preparation was performed in the same manner as in Example 1 except that Cu-0.3 Ag foil (semi-softening temperature: 310° C., conductivity: 102 IACS %) having a thickness of 15 μm was used as a negative electrode collector. The results are shown in Table 1.

### Example 4

Preparation was performed in the same manner as in Example 1 except that Cu-0.3 Mg foil (semi-softening temperature: 370° C., conductivity: 80 IACS %) having a thickness of 15 μm was used as a negative electrode collector. The results are shown in Table 1.

### Example 5

Preparation was performed in the same manner as in Example 1 except that Cu-0.2 Sn 0.05 Ag foil (semi-softening temperature: 340° C., conductivity: 84 IACS %) having a thickness of 15 μm was used as a negative electrode collector. The results are shown in Table 1.

### Example 6

Preparation was performed in the same manner as in Example 1 except that Cu-0.2 In 0.05 Ag (semi-softening temperature: 300° C., conductivity: 84 IACS %) having a thickness of 15 μm was used as a negative electrode collector. The results are shown in Table 1.

### Example 7

Preparation was performed in the same manner as in Example 1 except that Cu-0.01 Ti 0.05 Ag foil (semi-softening temperature: 365° C., conductivity: 91 IACS %) having a thickness of 15 μm was used as a negative electrode collector. The results are shown in Table 1.

### Example 8

Preparation was performed in the same manner as in Example 1 except that Cu-0.05 Zr 0.05 Sn foil (semi-softening temperature: 375° C., conductivity: 95 IACS %) having a thickness of 15 μm was used as a negative electrode collector. The results are shown in Table 1.

### Example 9

Preparation was performed in the same manner as in Example 1 except that Cu-0.2 In 0.01 Ti (semi-softening temperature: 330° C., conductivity: 80 IACS %) having a thickness of 15 μm was used as a negative electrode collector. The results are shown in Table 1.

### Example 10

Preparation was performed in the same manner as in Example 1 except that Cu-0.05 Sn 0.05 Ag 0.01 Ti foil (semi-softening temperature: 350° C., conductivity: 89 IACS %) having a thickness of 15 μm was used as a negative electrode collector. The results are shown in Table 1.

### Example 11

Preparation was performed in the same manner as in Example 10 except that lithium cobalt oxide (LiCoO₂, manufactured by Nichia Corporation) was used as a positive electrode active material. The results are shown in Table 1.

### Example 12

Preparation was performed in the same manner as in Example 10 except that lithium manganese oxide (LiMnO₄, manufactured by NIPPON DENKO Co., Ltd.) was used as a positive electrode active material. The results are shown in Table 1.

### Example 13

Preparation was performed in the same manner as in Example 10 except that polyamide-imide (trade name: HPC-1000, manufactured by Hitachi Chemical Co., Ltd.) as a negative electrode binder was used in place of the precursor of a negative electrode binder and a heat treatment was performed at 250° C. for 30 minutes. The results are shown in Table 1.

### Example 14

Preparation was performed in the same manner as in Example 10 except that tin oxide (manufactured by Kojundo Chemical Lab. Co., Ltd., average particle size D50=20 μm) was used as a negative electrode active material. The results are shown in Table 1.

### Example 15

Preparation was performed in the same manner as in Example 10 except that a silicon metal (manufactured by Kojundo Chemical Lab. Co., Ltd., average particle size D50=20 μm) was used as a negative electrode active material. The results are shown in Table 1.

### Example 16

Preparation was performed in the same manner as in Example 10 except that a tin metal (manufactured by Kojundo Chemical Lab. Co., Ltd., average particle size D50=20 μm) was used as a negative electrode active material. The results are shown in Table 1.

### Comparative Example 1

Preparation was performed in the same manner as in Example 1 except that tough pitch copper foil (semi-softening temperature: 100° C., conductivity: 100 IACS %) having a thickness of 15 μm was used as a negative electrode collector. The results are shown in Table 1.

### Comparative Example 2

Preparation was performed in the same manner as in Example 1 except that polyvinylidene fluoride (trade name: PVDF #1300 manufactured by Kureha Corporation) as a negative electrode binder was used in place of the precursor of a negative electrode binder and the heat treatment at 250° C. for 30 minutes was not performed. The results are shown in Table 1.

### Comparative Example 3

Preparation was performed in the same manner as in Example 15 except that polyvinylidene fluoride (trade name: PVDF #1300, manufactured by Kureha Corporation) as a negative electrode binder was used in place of the precursor of a negative electrode binder and the heat treatment at 250° C. for 30 minutes was not performed. The results are shown in Table 1.

### Comparative Example 4

Preparation was performed in the same manner as in Example 16 except that polyvinylidene fluoride (trade name: PVDF #1300, manufactured by Kureha Corporation) as a negative electrode binder was used in place of the precursor of a negative electrode binder and the heat treatment at 250° C. for 30 minutes was not performed. The results are shown in Table 1.

### Comparative Example 5

Preparation was performed in the same manner as in Example 1 except that Cu-0.1 Ti foil (semi-softening temperature: 360° C., conductivity: 91 IACS %) having a thickness of 15 μm was used as a negative electrode collector. The results are shown in Table 1.

TABLE 1

| | Negative electrode collector | | | | | | |
|---|---|---|---|---|---|---|---|
| | | Semi- | | Negative | | Positive | |
| | | softening | | electrode | Negative | electrode | Capacity |
| | | temperature | Conductivity | active | electrode | active | retention |
| | Material | (° C.) | (IACS %) | material | binder | material | rate (%) |
| Example 1 | Cu—0.1Sn | 330 | 91 | SiO | Polyimide | LiNiO₂ | 88 |
| Example 2 | Cu—0.2In | 320 | 83 | SiO | Polyimide | LiNiO₂ | 85 |
| Example 3 | Cu—0.3Ag | 310 | 102 | SiO | Polyimide | LiNiO₂ | 81 |
| Example 4 | Cu—0.3Mg | 370 | 80 | SiO | Polyimide | LiNiO₂ | 77 |
| Example 5 | Cu—0.2Sn0.05Ag | 340 | 84 | SiO | Polyimide | LiNiO₂ | 91 |
| Example 6 | Cu—0.2In0.05Ag | 300 | 84 | SiO | Polyimide | LiNiO₂ | 81 |
| Example 7 | Cu—0.01Ti0.05Ag | 365 | 91 | SiO | Polyimide | LiNiO₂ | 94 |
| Example 8 | Cu—0.05Zr0.05Sn | 375 | 95 | SiO | Polyimide | LiNiO₂ | 93 |
| Example 9 | Cu—0.2In0.01Ti | 330 | 80 | SiO | Polyimide | LiNiO₂ | 94 |
| Example 10 | Cu—0.05Sn0.05Ag0.01Ti | 350 | 89 | SiO | Polyimide | LiNiO₂ | 95 |
| Example 11 | Cu—0.05Sn0.05Ag0.01Ti | 350 | 89 | SiO | Polyimide | LiCoO₂ | 92 |
| Example 12 | Cu—0.05Sn0.05Ag0.01Ti | 350 | 89 | SiO | Polyimide | LiMnO₄ | 88 |
| Example 13 | Cu—0.05Sn0.05Ag0.01Ti | 350 | 89 | SiO | Polyamide- | LiNiO₂ | 94 |
| | | | | | imide | | |
| Example 14 | Cu—0.05Sn0.05Ag0.01Ti | 350 | 89 | SnO | Polyimide | LiNiO₂ | 91 |
| Example 15 | Cu—0.05Sn0.05Ag0.01Ti | 350 | 89 | Si | Polyimide | LiNiO₂ | 74 |
| Example 16 | Cu—0.05Sn0.05Ag0.01Ti | 350 | 89 | Sn | Polyimide | LiNiO₂ | 72 |
| Comparative | Tough pitch copper foil | 100 | 100 | SiO | Polyimide | LiNiO₂ | 40 |
| Example 1 | | | | | | | |
| Comparative | Cu—0.1Sn | 330 | 91 | SiO | PVDF | LiNiO₂ | 30 |
| Example 2 | | | | | | | |
| Comparative | Cu—0.05Sn0.05Ag0.01Ti | 350 | 89 | Si | PVDF | LiNiO₂ | 12 |
| Example 3 | | | | | | | |
| Comparative | Cu—0.05Sn0.05Ag0.01Ti | 350 | 89 | Sn | PVDF | LiNiO₂ | 9 |
| Example 4 | | | | | | | |
| Comparative | Cu—0.1Ti | 360 | 91 | SiO | Polyimide | LiNiO₂ | 52 |
| Example 5 | | | | | | | |

As described above, it is found that nonaqueous electrolyte secondary batteries obtained in Examples 1 to 16 have high capacity retention rates and satisfactory cycle characteristics, compared to nonaqueous electrolyte secondary batteries obtained in Comparative Examples 1 to 5.

The present application claims a priority based on Japanese Patent Application No. 2010-197835 filed on Sep. 3, 2010, the disclosure of which is incorporated in its entirety herein.

In the above, the invention of the present application has been described by way of exemplary embodiments and Examples; however, the invention of the present application is not limited to the above exemplary embodiments and Examples. The constitution and details of the invention of the present application can be modified in various ways within the scope of the invention of the present application as long as those skilled in the art can understand them.

### REFERENCE SIGNS LIST

a Negative electrode
b Separator
c Positive electrode
d Negative electrode collector
e Positive electrode collector
f Positive electrode terminal
g Negative electrode terminal

1. A negative electrode for a secondary battery formed by bonding a negative electrode active material to a negative electrode collector with a negative electrode binder, wherein
the negative electrode binder is a polyimide or a polyamide-imide, and
the negative electrode collector is a Cu alloy comprising at least one metal (a) selected from the group consisting of Sn, In, Mg and Ag and has a conductivity of 50 IACS % or more.

2. The negative electrode for a secondary battery according to claim 1, wherein the Cu alloy comprises 0.01 to 0.3% by mass of the metal (a).

3. The negative electrode for a secondary battery according to claim 2, wherein the Cu alloy comprises 0.05 to 0.2% by mass of Sn as the metal (a).

4. The negative electrode for a secondary battery according to claim 1, wherein the negative electrode collector has a semi-softening temperature of 250° C. or more.

5. The negative electrode for a secondary battery according to claim 1, wherein the negative electrode active material is a metal or metal oxide comprising silicon or tin.

6. A method for manufacturing a negative electrode for a secondary battery according to claim 1, comprising
forming a negative electrode layer comprising the negative electrode active material and a precursor of the negative electrode binder on the negative electrode collector; and
bonding the negative electrode active material to the negative electrode collector with the negative electrode binder by curing the precursor of the negative electrode binder at 250 to 350° C.

7. The method for manufacturing a negative electrode for a secondary battery according to claim 6, wherein the precursor of the negative electrode binder is polyamic acid and the negative electrode binder is a polyimide.

8. A nonaqueous electrolyte secondary battery formed by wrapping an electrode element, in which a positive electrode and a negative electrode are arranged so as to face each other, and a nonaqueous electrolyte in an outer package, wherein the negative electrode is a negative electrode for a secondary battery according to claim 1.

9. The negative electrode for a secondary battery according to claim 2, wherein the negative electrode collector has a semi-softening temperature of 250° C. or more.

10. The negative electrode for a secondary battery according to claim 3, wherein the negative electrode collector has a semi-softening temperature of 250° C. or more.

11. The negative electrode for a secondary battery according to claim 2, wherein the negative electrode active material is a metal or metal oxide comprising silicon or tin.

12. The negative electrode for a secondary battery according to claim 3, wherein the negative electrode active material is a metal or metal oxide comprising silicon or tin.

13. The negative electrode for a secondary battery according to claim 4, wherein the negative electrode active material is a metal or metal oxide comprising silicon or tin.

14. The negative electrode for a secondary battery according to claim 9, wherein the negative electrode active material is a metal or metal oxide comprising silicon or tin.

15. The negative electrode for a secondary battery according to claim 10, wherein the negative electrode active material is a metal or metal oxide comprising silicon or tin.

16. A method for manufacturing a negative electrode for a secondary battery according to claim 2, comprising
forming a negative electrode layer comprising the negative electrode active material and a precursor of the negative electrode binder on the negative electrode collector; and
bonding the negative electrode active material to the negative electrode collector with the negative electrode binder by curing the precursor of the negative electrode binder at 250 to 350° C.

17. A method for manufacturing a negative electrode for a secondary battery according to claim 3, comprising
forming a negative electrode layer comprising the negative electrode active material and a precursor of the negative electrode binder on the negative electrode collector; and
bonding the negative electrode active material to the negative electrode collector with the negative electrode binder by curing the precursor of the negative electrode binder at 250 to 350° C.

18. A method for manufacturing a negative electrode for a secondary battery according to claim 4, comprising
forming a negative electrode layer comprising the negative electrode active material and a precursor of the negative electrode binder on the negative electrode collector; and
bonding the negative electrode active material to the negative electrode collector with the negative electrode binder by curing the precursor of the negative electrode binder at 250 to 350° C.

19. A method for manufacturing a negative electrode for a secondary battery according to claim 5, comprising
forming a negative electrode layer comprising the negative electrode active material and a precursor of the negative electrode binder on the negative electrode collector; and
bonding the negative electrode active material to the negative electrode collector with the negative electrode binder by curing the precursor of the negative electrode binder at 250 to 350° C.

20. A method for manufacturing a negative electrode for a secondary battery according to claim 9, comprising
forming a negative electrode layer comprising the negative electrode active material and a precursor of the negative electrode binder on the negative electrode collector; and
bonding the negative electrode active material to the negative electrode collector with the negative electrode binder by curing the precursor of the negative electrode binder at 250 to 350° C.
